(19) United States
(12) Patent Application Publication
(10) Pub. No.: US 2012/0038140 A1
(43) Pub. Date: Feb. 16, 2012

(54) CUSTOMISED SECURE DOCUMENT AND PROCEDURE FOR SECURING A DOCUMENT

(75) Inventors: Antoine Dhome, Bussy Saint Georges (FR); Francoise Daniel, Champs Sur Marne (FR); Christophe Duriez, Bry Sur Marne (FR)

(73) Assignee: HOLOGRAM INDUSTRIES, Bussy St Georges (FR)

(21) Appl. No.: 13/145,045

(22) PCT Filed: Jan. 18, 2010
(86) PCT No.: PCT/FR10/00041

§ 371 Date: Nov. 4, 2011

(30) Foreign Application Priority Data
Jan. 28, 2009 (FR) 09/00372

(51) Int. Cl. B42D 15/00

(52) U.S. Cl. 283/67; 283/85

(57) ABSTRACT

A method for securing a document (1), and a secure document (1) including a data medium (2) and an optical security component (3). The medium (2) includes a first surface (12) and a second surface (13). The optical component (3) includes an element (21) for generating optical effects and an adhesive element (5) adhering to the first surface (21) of the medium (2). Customization data (16,17,18,19,20) are written on the secure document (1). The secure document (1) also includes an additional sealing component (4) including adhesive element (10) adhering to the second surface (13) of the medium (2), the medium (2) including at least one perforation (14, 15) arranged so that the optical (3) and additional (4) components are bonded to each other through the perforation (14, 15).

### TECHNICAL FIELD OF THE INVENTION

The present invention relates to the field of securing documents, such as passports, on which customisation data is written.

It relates more specifically to a document being secured including a data medium and an optical security component, the medium including two surfaces, the optical component including means capable of generating optical effects and adhesive means adhering to a surface of the medium, customisation data being written on the document.

It likewise relates to a method for securing a document including a data medium including two surfaces, the method including a step of transferring an optical security component onto a surface of the medium, the security component including means capable of generating optical effects and adhesive means adhering to the first surface of the medium.

### PRIOR ART

Identity documents such as passports are the target of a large number of counterfeiting attempts aiming to falsify customisation data in order to replace same and to thus divert the use of the passport, which is the case, in particular, with stolen passports.

In order to authenticate and protect said customised data, it is known to cover the printed page, or data medium, with a set of holographic protective layers, as described, for example, in the patent document EP 0 708 935. This operation can be carried out by transferring a set of protective layers, e.g., during a laminating step. These protective layers further comprise optical security elements comprising a laminate. Said optical security elements consist of one or more protective films or varnishes, a layer comprising a diffracting optical microstructure, a reflective layer and an adhesive layer. The laminate is bonded to the printed page by the adhesive layer. It is generally of a small thickness so as to counteract the risks of the document being falsified by tearing away the laminate. Prior to being transferred onto the printed page, the laminate can likewise include a backing film and a separation layer. During the transfer, all of the layers of the laminate are transferred onto the document being protected, with the exception of the backing film and the separation layer, which are removed. In this way, one has a secure document comprising a data medium covered with an optical component comprising a set of holographic protective layers.

However, despite the small thickness of the protective layers, this type of solution has the disadvantage of making falsification too easy by separating the holographic component from the rest of the document, e.g., by using a suitable commercially available solvent. The falsification resistance is therefore not high enough with this type of solution.

One solution for strengthening the prevention of the holographic component being torn away is proposed in the patent document US 2007/246931. In this publication, an identity document comprises customisation data printed or bonded to a data medium. It likewise includes holographic protective layers as well as an electronic circuit arranged on the data medium and enabling radiofrequency identification. The protective layers and the electronic circuit are covered by a film. Separation of the protective layers and the electronic circuit is thus made impossible without irreversibly destroying the film covering the circuit. Detecting the destruction of said film is sufficiently easy so that falsification is recognisable immediately.

However, this solution has the disadvantage of requiring the use of electronic means which, on the one hand, involve a significant additional cost for the document and, on the other hand, greater manufacturing complexity.

Thus, no solution of the prior art makes it possible to provide high resistance to falsification by tearing away the protective holographic components, while at the same time being inexpensive and easy to manufacture.

### DISCLOSURE OF THE INVENTION

The present invention proposes to remedy this technical problem by using at least one perforation made in the data medium and by arranging, in addition to the first optical component on one surface of the data medium, a second sealing component on the other surface of the medium. Said two components, each comprising an adhesive layer, completely cover over a perforation and adhere to one another therethrough, thereby enabling same to be sealed on either side of the medium.

The approach of the solution consists in looking for means to prevent the optical security component from being torn away without irreversibly damaging same. It then became apparent that the adhesive covering of each surface of the data medium by two components, combined with one or more perforations made solely in the medium, enabled the optical security component to be sealed inexpensively and in an industrially easy-to-implement manner.

To that end, the invention relates to a secure document including a data medium and an optical security component, the medium including a first surface and a second surface, the optical component including means capable of generating optical effects and adhesive means adhering to the first surface of said medium, customisation data being written on said secure document. Said secure document likewise includes an additional sealing component including adhesive means adhering to the second surface of said medium, said medium comprising at least one perforation arranged such that said optical and additional components are bonded to one another through the perforation.

By the arrangement of a perforation and two components completely covering same and arranged on either side of the data medium, the two components are thereby sealed. Consequently, when a forger attempts to tear away the optical component, comprising a holographic material, from the data medium, the additional component is likewise torn away as a result of said sealing, which will therefore result in the entire secure document being torn completely. In addition, the customisation data printed on the security component at the location of the perforation will likewise be destroyed.

Customisation data is preferably written on at least the optical component or the additional component in the area of at least one perforation through which the optical and additional components are bonded to one another. In this way, there is transparency control of an additional security element in the area of a perforation. Verification of this new element is done by simply observing the security data printed on one of the components transparently through the perforation. In the case of a passport, said security data can be customised, e.g., an identifier or identity photo. In addition, if a forger attempts to tear away the optical component by having previously cut-out the portion of the components arranged in the area of the perforation, it will be easy to transparently detect the absence of said additional security data. Detection of such a falsification is thereby rendered immediate.

A perforation is understood to mean an opening or notch made in the data medium. Said perforation can thus be arranged on an edge of the medium, and therefore not entirely surrounded by the medium, or elsewhere.

According to a particular embodiment, at least one perforation through which the optical and additional components are bonded to one another is an opening arranged inside the surface of the medium.

According to another particular embodiment, at least one perforation through which the optical and additional components are bonded to one another is a notch arranged on an edge of the surface of the medium.

The adhesive means of the optical component preferably include a transparent adhesive layer.

The means of the optical component which are capable of generating optical effects preferably include a reflective transparent layer and a stamped layer comprising a microrelief optical structure.

According to a particular embodiment, said optical structure consists of a diffraction grating producing diffraction effects visible at the zero-order or first-order spectrum.

The optical structure is advantageously arranged relative to the reflective transparent layer so as to structure a surface of the reflective transparent layer.

Likewise advantageously, the reflective transparent layer is placed on top of the transparent adhesive layer and the stamped layer is placed on top of the reflective transparent layer. Said reflective transparent layer can be made of a transparent dielectric material.

The optical component likewise preferably includes at least one film having protective mechanical resistance so as to protect from possible damage.

According to a preferred embodiment, the additional component likewise comprises means capable of generating optical effects. In this way, there is optical security on each of the surfaces of the document, which further enhances the security thereof.

According to another preferred embodiment, the first surface and the second surface of the medium are completely covered by the optical and additional components, respectively. On the one hand, this makes it possible to protect the data medium in its entirety and, on the other hand, to have a larger surface for the two components, thereby making it all the more difficult to tear away such a surface.

At least the optical component or the additional component preferably comprises at least one thick layer. The secure document is made thicker and therefore easier to handle. In addition, this thickness makes it possible to compensate for the holes caused by the perforations, thereby preventing said perforations from being noticeable. In the case where a single component supports a holographic material, the thick layer is preferably arranged on the component which does not support any holographic material. It is indeed preferable to have a holographic component of small thickness in order to make the tearing of same all the more difficult. In the case where the two components support a holographic material, it is thus preferable to transfer the thin film onto the surface comprising the photo.

The secure document likewise advantageously comprises an antenna. Said antenna enables signal amplification with a view to communicating with a contactless chip. In the case of a passport, said chip, for example, can be integrated into the cover thereof or into a thick layer.

According to a particular embodiment, the medium is a medium capable of being printed by means of fixed printing. The medium is therefore capable of enabling customisation data to be written on at least one surface thereof.

According to another particular embodiment, the adhesive means of the optical component consist of a transparent adhesive layer which is heat-activated and capable of being printed by variable printing. This layer thus makes it possible to print customisation data thereon prior to same being bonded to the data medium. Therefore, a choice can be made to print the data on the first surface of the data medium or on the adhesive layer of the optical component.

According to another particular embodiment, the adhesive means of the additional component consist of a transparent adhesive layer which is heat-activated and capable of being printed by variable printing. Said layer thus makes it possible to print customisation data thereon prior to same being bonded to the data medium. Data can therefore be printed on the second surface of the data medium or on the adhesive layer of the additional component, with a view to multiplying the amount of customisation data visible through the perforation.

Security customisation data can thus be printed both on the data medium and on each of the two components, thereby enhancing the security of the document all the more by multiplying the media on which customisation data is written.

Included in the customisation data is some which is visible, which enables essential identification data to be obtained immediately and legibly, e.g., such as a name, an identifier or a photo.

According to a particular embodiment, customisation data is visible. The use of a security ink provides additional security to the document. The security ink used can have a wavelength within the infrared or ultraviolet range, for example. A reading means suited to the selected wavelength is then required.

In all of the aforementioned embodiments, the data medium can, in particular, be made of paper or plastic (e.g., polycarbonate).

The invention likewise relates to a method for securing a document including a data medium including a first surface and a second surface. Said method includes a step of writing customisation data on the document and a step of transferring an optical security component onto the first surface of the medium, the optical component including means capable of generating optical effects and adhesive means adhering to the first surface of said medium. According to the invention, said method likewise includes a preliminary step of perforating the medium and a step of transferring an additional sealing component onto the second surface of the medium, the additional component including adhesive means adhering to the second surface of the medium, such that the transferred optical and additional components are bonded to one another through at least one perforation.

Preferably, prior to the steps of transferring the optical component and additional component, a step of writing customisation data on the optical component or the additional component in the area of at least one perforation through which the transferred optical and additional components will be bonded to one another. Once the document has been secured, this writing of additional data will enable an additional verification means to be had, which will be implemented by merely observing said transparent data through the perforation in question.

The steps of transferring the optical component and the additional component are likewise preferably carried out simultaneously using a transfer medium on which the optical and additional components are arranged on other side of the fold line. In this way, there is a single transfer medium for both components, thereby making it possible to not only economise on the component medium but to likewise correctly position the two components on either side of the fold line relative to the data medium, with a view to transferring same thereon. Folding the transfer medium enables the two components to be arranged opposite one another on either side of the medium being protected. In addition, this enables the two transfer steps to be carried out simultaneously in a single step. It is likewise ensured that the two adhesive layers 5 and 10 are activated at the same time and that bonding thus occurs both on the two surfaces of the medium and in a perforation for attaching the two components to one another.

According to a particular embodiment of the method according to the invention, the step of transferring the optical component consists in preparing a transfer film including a backing film coated with a separation layer, which is itself coated with an optical component, in applying the transfer film to the first surface of the medium, and in then removing the backing film and the separation layer from the transfer film of the separation layer.

According to another particular embodiment, the optical component is obtained by coating a film having protective mechanical resistance with a layer stamped with a microrelief optical structure, a reflective transparent layer and an adhesive layer.

### BRIEF DESCRIPTION OF THE FIGURES

Other characteristics and advantages of the invention will emerge upon reading the following description, with reference to the appended figures, which show:

FIG. 1, a top diagram of the first surface of a secure document according to a particular embodiment of the invention,

FIG. 2, a top diagram of the second surface of a secure document according to a particular embodiment of the invention,

FIG. 3, a cross-sectional diagram of a secure document according to a particular embodiment of the invention,

FIG. 4, a diagram showing the step of transferring the optical component onto the document being secured according to a particular embodiment, and

FIG. 5, a diagram showing a method for securing a document by folding and simultaneously transferring two components according to a particular embodiment of the invention.

For the sake of clarity, identical or similar elements are referenced by identical reference signs in all of the figures.

### DETAILED DESCRIPTION OF AN EMBODIMENT

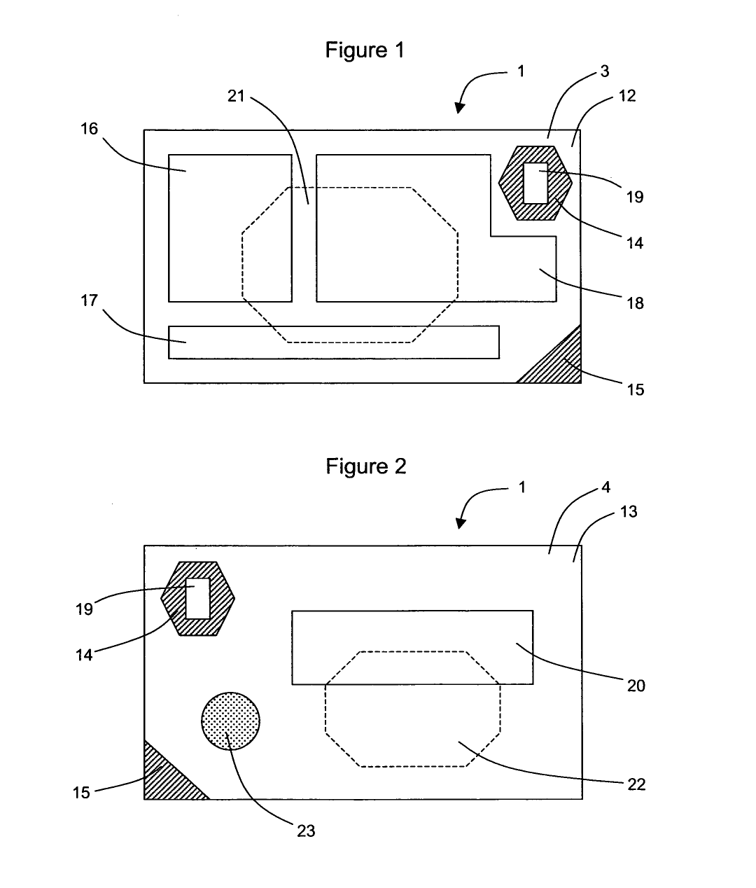

As shown in FIG. 1, which shows a top view of the first surface of the secure document 1 according to the invention, said document includes a data medium 2 and an optical security component 3.

In a particular embodiment of the invention, the secure document 1 is a personal document associated with a passport-type holder, identification card or driver's license. The medium 2 then corresponds to a page or sheet of said secure document 1. The medium 2 can be made of various materials, depending on the nature of the secure document 1, and particularly of paper or plastic (e.g., polycarbonate).

The medium 2 includes a first surface 12 and a second surface 13. Only the first surface 12 is visible in FIG. 1, the second surface 13 being shown in FIG. 2. Customisation data 16, 17, 18 and 19 is written on the first surface 12 of the medium 2. This customisation data is written on the medium 2 by means of fixed printing. Same is selected so as to provide personal information about the holder of the secure document, e.g., a photo of the holder, civilian contact information (last name, first name, address, date of birth, etc.), identifiers, etc.

According to the invention, the medium 2 comprises at least one perforation 14. Such a perforation is in the form of an opening 14 made in the medium 2, within the thickness thereof. It is used to seal the secure document 1. It can be completed with other perforations, e.g., such as a notch on an edge of the medium 2, within the thickness thereof.

The optical security component 3 is in the form of a transparent or partially transparent film, covering the first surface 12 of the medium 2, preferably over the entire surface thereof. It is arranged so as to completely cover at least the perforations 14 and 15 which are used to seal the secure document 1. Said component 3 comprises a laminate to be bonded to a document or a product so as to protect same from normal wear and tear (physico-chemical resistance) and to likewise prevent wilful defacement of the elements protected by the film.

From an industrial standpoint, a plurality of components 3 can be manufactured in series on a single medium (film or paper) for storage purposes. The component 3 being used to secure the document 1 is then detached from said storage medium in order to be brought to said document 1 being secured via an intermediate medium 24.

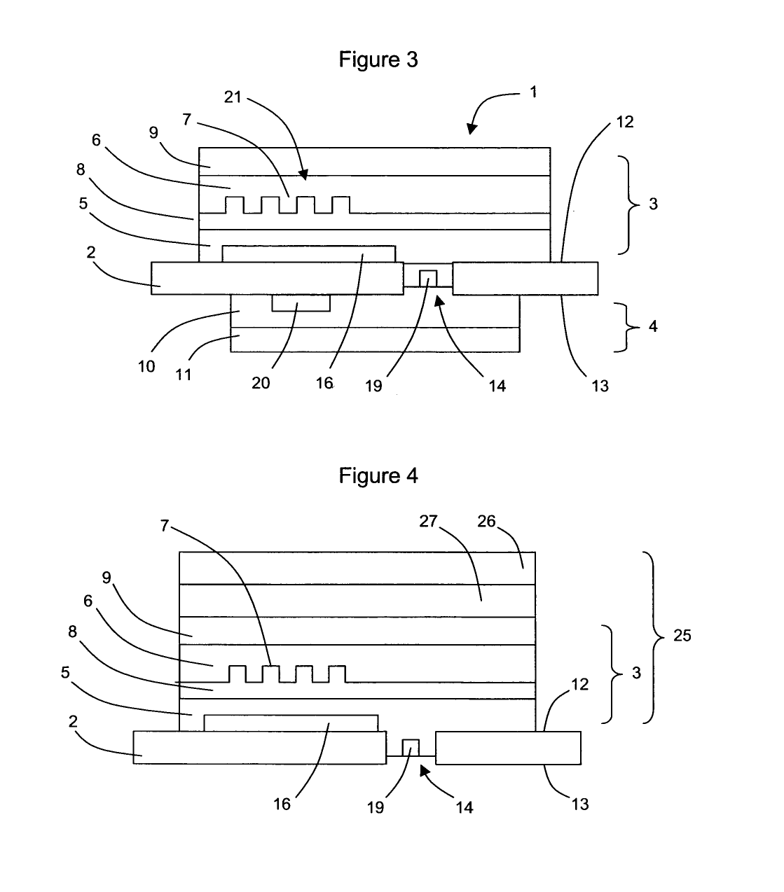

With reference to FIG. 3, the optical component 3 includes means 21 capable of generating optical effects, adhesive means 5 adhering to the first surface 12, as well as protective means 9.

The adhesive means 5 consist of a transparent adhesive layer 5 which are made, for example, of an adhesive which is transparent to light signals in the visible range, is heat-activated and is capable of being printed by variable printing.

The protective means 9 consist of a protective varnish covering the entire outer surface of the optical component 3 so as to protect same. To that end, the varnish used is resistant to scratching and chemical products.

The means 21 capable of generating optical effects include a reflective transparent layer 8 and a stamped layer 6. The stamped layer 6 comprises an optical microrelief structure 7, which is capable of producing diffraction or holographic effects. Layer 6 can thus be a stamping layer or a thermoformable layer. Said means 21 are preferably placed on top of a portion of the customisation data written on said document.

The optical structure 7 preferably consists of a diffraction grating producing diffraction effects visible at the zero-order or first-order spectrum, or any other optical microstructure producing such effects.

The stamped transparent layer 6 is placed on top of the reflective layer 8, which is itself placed on top of the adhesive layer 5. The optical structure 7 extends to the interface between the stamped layer 6 and the reflective layer 8, such that the reflective layer 8 is itself surface-microstructured. Consequently, the reflecting surface 8 is preferably transparent throughout the thickness thereof.

The reflective layer 8, for example, is a layer made of a ZnS-type dielectric material which is deposited by vapour deposition or any other known method. It can likewise be of a metallic nature and can be applied uniformly. The nature and thickness of said reflective layer 8 are customised to the optical effect generated by the stamped layer 6.

In another embodiment of the invention, the customisation data 16, 17, 18 and 19 is not written on the medium 2 by means of fixed printing but on the adhesive layer 5 of the optical component 3 by variable printing. It can likewise be provided for a portion of the data to be printed on the medium 2 and the remainder on the adhesive layer 5.

As shown in FIG. 2, which shows a top view of the second surface of the secure document 1 according to the invention, the document likewise includes an additional sealing component 4. Said additional component is in the form of a transparent film covering the second surface 13 of the medium 2, and preferably the entire surface thereof. In the same way as the optical component 3, the additional component 4 is arranged so as to completely cover at least the perforations 14 and 15 which are used for sealing the secure document 1.

From an industrial standpoint, the additional components 4 can be stored in a way similar to the optical components 3.

With reference to FIG. 3, the additional component 4 includes adhesive means 10 and protective means 11. The adhesive means 10 consist of a transparent adhesive layer 10, which, for example, is made of an adhesive similar to that used for the transparent adhesive layer 5. The protective means 11 consist of a film having protective mechanical resistance 11, which covers the entire outer surface of the additional component 4 so as to protect same.

The optical component 3 and the additional component 4 thus come into contact in the perforations 14 and 15, by means of the respective adhesive layers 5 and 10 thereof. Said layers 5 and 10 are capable of deforming in the perforations so as to be bonded to one another, thereby enabling the optical component 3 and the additional component 4 to be bonded to one another through said perforations. Consequently, when a forger separates the optical security component 3, the additional component 4 to which same is sealed will likewise be torn away, thereby causing an irreversible defacement of the optical component 3, and more generally speaking the secure document 1.

The term perforation designates both an opening and a notch in the thickness of the medium. A person skilled in the art will understand that the larger the dimensions of the perforations, the larger the sealing surface between the two components, and therefore the more effective the security seal.

Advantageous embodiments of the invention will now be described still with reference to FIGS. 1 to 3.

The secure document includes customisation data 19 in the opening 14. Said data 19 is written on the optical component 3 or on the additional component 4, by variable printing. Said data 19, for example, can be a photo of the holder of the document or an identifier. This portion of the document can then be easily verified by transparency, which offers an additional level of security to the document 1 by maximising the use of the perforations made therein.

By thus making a perforation, on which combined operations are carried out for sealing the optical component with an additional component, through the perforation, and for writing security customisation data, a secure document, which is both untearable and easy to verify transparently is obtained, in addition to optical holography securement. The document 1 is therefore all the more secure.

According to other embodiments of the invention, other perforations can be made in the data medium 2, additional customisation data being arranged in each perforation. The document will thereby be all the more transparently secure and from the viewpoint of the prevention of fraud by tearing.

In addition to the customisation data 16, 17 and 18 of the first surface 12 of the document, customisation data 20 can be written on the second face of the secure document 1 (FIG. 2).

Also on said second surface, an antenna 23 can be added on, which is integrated into a thick layer of the secure document 1 such as layer 11. In the case of a passport, it is likewise possible to integrate same into the cover thereof. As a supplement to the sealing of the document via the perforations 14 and 15 and the and the additional component 4, said antenna 23 enables communication with a contactless chip, with a view to detecting a fraudulent act involving the tearing away of portion of the document.

Writing several types of customisation data 16, 17, 18, and 20 is possible. In particular, a portion of the customisation data is visible, thereby enabling same to be made available immediately. Other data is invisible, due to the use of a security ink having a wavelength in the infrared or ultraviolet range, as well as an appropriate reading means. Finally, other data can be reactivated by using a reactivatable marking means and an appropriate reactivation means.

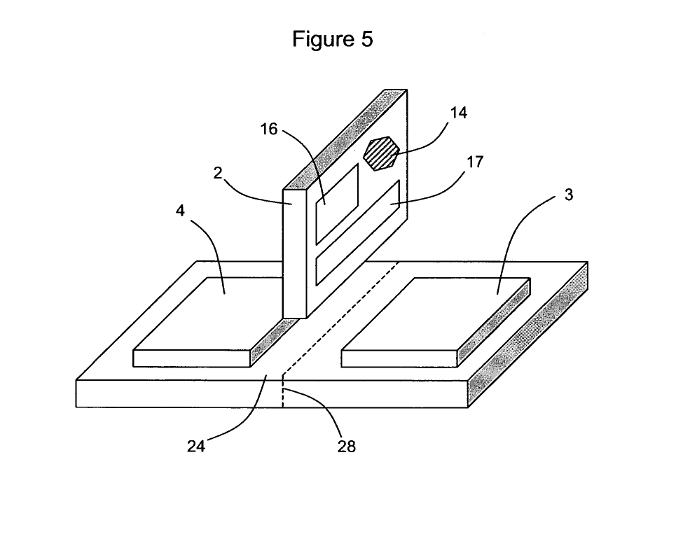

A method will now be described for securing a document according to the invention, with reference to FIGS. 4 and 5.

The unsecured starting document includes a data medium 2. Said medium includes a first surface 12 and a second surface 13. To obtain a secure document according to the invention, it is further necessary to perforate the medium 2, as well as to transfer the optical security component 3 and additional sealing component 4.

The optical component 3 and the additional component have structures similar to those of these same components described above with reference to FIGS. 1 to 3.

The first step is a customisation step, consisting in writing customisation data 16, 17, 18, 19 and 20 on the document. Said data can be written directly on one of the surfaces or both surfaces of the medium, on the adhesive layer 5 of the optical component 3 and on the adhesive layer 10 of the additional component 4. The writing is done by fixed printing or variable printing, based on the nature of the elements being printed. For example, for aesthetic purposes, the name of the field and the value thereof (i.e., “NOM: DANIEL”, etc.) are printed at the same time. As appropriate, the fixed or variable information elements are written by ink-jet, laser or other printing means.

Prior to transferring the two components onto the medium 2, the next step consists in making a perforation 14 in the medium 2. Said perforation 14 is an opening made in the thickness of the medium 2. It can be completed by a certain number of other perforations, with a view to sealing the document all the more effectively.

The following steps consist in transferring the optical component 3 and the additional component 4 onto each of the surfaces of the medium 2, bonding being ensured by the adhesive layers 5 and 10 of the two components.

With reference to FIG. 4, transferring the optical component 3 consists in attaching the protective layers, including, in particular, the means 21 capable of generating optical effects, onto the document being protected, during a laminating step. Prior to being transferred, the optical component 3, or laminate, is supported by a backing film 26 coated with a separation layer 27. Consequently, the transfer film 25 thus produced successively includes a backing film 26, a separation layer 27, one or more protective varnish layers 9, a stamped layer 6 comprising an optical microstructure 7, a reflective layer 8 and an adhesive layer 5.

The backing film 26, for example, is made of polyester. This polyester film can be arranged on a spool of 12 to 100 μm thickness, typically 19 μm. The assembly 25 is coated with an adhesive film on the free surface of the backing film 26 and with a silicone-coated substrate so as to be capable of converting the component being transferred in the form of a cut-out label to the format being transferred onto the silicone-coated substrate, whereby the silicone-coated substrate includes a set of labels so as to facilitate the storage thereof and the subsequent transfer of same onto a substrate of type 24. The separation layer 27, which is made of wax, for example, is used for subsequently detaching the layers being transferred.

Said layers are transferred onto the medium 2 according to laminating techniques well-known to a person skilled in the art. During the transfer, all of said layers are transferred onto the document being protected, with the exception of the backing film 26 and the separation layer 27, which are removed. This removal occurs at the separation layer 27. Only the optical component 3 then remains bonded to the first surface 12 of the medium 2.

Transfer of the additional component 4 can then occur during a similar transfer step, onto the second surface 13 of the medium 2. The transfer steps for each of the two components can be carried out successively or simultaneously, based on the available laminating means. In the case of a hot-setting adhesive, the transfer of the two components is carried out in a single step. In the case of a cold-setting adhesive, the transfer is carried out in two steps; however this latter possibility is of lesser interest since it is then impossible to print onto the components.

A person skilled in the art will note that several types of material can be used to produce the adhesive layers 5 and 10 of the two components, in particular heat-activated transparent adhesives or transparent adhesives which to not require heat activation, in other words pressure-sensitive adhesives.

After transferring the two components 3 and 4, same are bonded to one another through the perforation 14, the adhesive layers 5 and 10 being capable of deforming slightly so as to penetrate into the perforation 14 and thereby come into contact with one another. The two components, arranged on either side of the data medium 2, are thus sealed.

During the step of customising the document 1, customisation data 19 can be written on one of the adhesive layers 5 or 10, by variable printing, in the area of the perforation 14. After the two components 3 and 4 have been transferred, said data 19 is intended to be verified by reading the document transparently, which offers an additional and perfectly legible degree of security in the sealing area. Said sealing area is thus used by combining sealing and transparent secure verification.

With reference to FIG. 5, and according to a particularly advantageous mode of carrying out the aforementioned transfer steps, the latter are carried out simultaneously using a single backing film 24. The two components 3 and 4 are appropriately arranged on said film 24, on either side of a fold line 28. Folding the backing film 24 along said fold line 28 enables the two surfaces of the medium 2 to be covered in one move, and laminating techniques can be applied simultaneously on each side of the document so as to carry out the transfer at the same time. The backing film 24, as well as layer 26 and the separation layer 27 are then removed so as to leave only component 3. A similar structure enables only component 4 to be left on the other surface. In this way, the introduction of additional manufacturing steps is avoided. It is likewise ensured that the two adhesive layers 5 and are activated at the same time and also that bonding occurs both on the two surface of the medium 2 and in a perforation for attaching the two components together.

In all of the above-mentioned embodiments, the medium 2 can be a page or a sheet of a personal document such as an identification card, passport or driver's license.

The above-described embodiments of the present invention are given for purely non-limiting and illustrative purposes. It is understood that a person skilled in the art would be capable of producing various alternatives of the invention without thereby departing from the scope of the patent.

In particular, provisions can be made for the customisation element written on the perforation area to be a photograph of the document holder, written as a mirror image, for example. Provisions can likewise be made for the optical elements to cover the photograph of the holder as well as the perforations required for sealing the document. Finally, provisions can be made for the perforations to assume the shape of the geographic map of the country of origin of the holder, when the secure document is of the passport type.

1. Secure document (1) including a data medium (2) and an optical security component (3), the medium (2) including a first surface (12) and a second surface (13), the optical component (3) including means (21) capable of generating optical effects and adhesive means (5) adhering to the first surface (12) of said medium (2), customisation data (16, 17, 18, 19, 20) being written on said secure document (1), characterised in that it likewise includes an additional sealing component (4) including adhesive means (10) adhering to the second surface (13) of said medium (2), said medium (2) comprising at least one perforation (14, 15) arranged such that said optical (3) and additional (4) components are bonded to one another through the perforation (14, 15) by means of the respective adhesive layers (5, 10) thereof.

2. Secure document (1) according to claim 1, wherein customisation data (19) is written on at least the optical component (3) or the additional component (4) in the area of at least one perforation (14) through which the optical (3) and additional (4) components are bonded to one another.

3. Secure document (1) according to claim 1, wherein at least one perforation (14) through which the optical (3) and additional (4) components are bonded to one another is an opening arranged inside the surface of the medium (2).

4. Secure document (1) according to claim 1, wherein at least one perforation (15) through which the optical (3) and additional (4) components are bonded to one another is a notch arranged on an edge of the surface of the medium (2).

5. Secure document (1) according to claim 1, wherein the adhesive means (5) of the optical component (3) include a transparent adhesive layer (5).

6. Secure document according to claim 1, wherein the means (21) of the optical component (3) which are capable of generating optical effects include a reflective transparent layer (8) and a stamped layer (6) comprising a microrelief optical structure (7).

7. Secure document (1) according to claim 6, wherein the optical structure (7) consists of a diffraction grating producing diffraction effects visible at the zero-order or first-order spectrum.

8. Secure document according to claim 6, wherein the optical structure (7) is arranged relative to the reflective transparent layer (8) so as to structure a surface of the reflective transparent layer (8).

9. Secure document according to claim 6, wherein the adhesive means (5) of the optical component (3) include a transparent adhesive layer (5), and the reflective transparent layer (8) is placed on top of the transparent adhesive layer (5) and the stamped layer (6) is placed on top of the reflective transparent layer (8).

10. Secure document (1) according to claim 1, wherein the optical component (3) likewise comprises at least one protective varnish (9) covering the entire outer surface of the optical component (3).

11. Secure document (1) according to claim 1, wherein the additional component (4) likewise comprises means (22) capable of generating optical effects.

12. Secure document (1) according to claim 1, wherein the first (12) and second (13) surfaces of the medium (2) are completely covered by the optical (3) and additional (4) components, respectively.

13. Secure document (1) according to claim 1, wherein at least the optical component (3) or the additional component (4) comprises at least one thick layer (11).

14. Secure document (1) according to claim 1, comprising an antenna (23).

15. Secure document (1) according to claim 1, wherein the medium (2) is a medium capable of being printed by means of fixed printing.

16. Secure document (1) according to claim 1, wherein the adhesive means (5) of the optical component (3) consist of a transparent adhesive layer which is heat-activated and capable of being printed by variable printing.

17. Secure document (1) according to claim 1, wherein the adhesive means (10) of the additional component (4) consist of a transparent adhesive layer which is heat-activated and capable of being printed by variable printing.

18. Secure document (1) according to claim 1, wherein customisation data (17) is invisible.

19. Method for securing a document (1) including a data medium (2) including a first surface (12) and a second surface (13), the method including a step of writing customisation data (16, 17, 18, 19, 20) on the document (1) and a step of transferring an optical security component (3) onto the first surface (12) of the medium (2), the optical component (3) including means (21) capable of generating optical effects and adhesive means (5) adhering to the first surface (12) of said medium (2), characterised in that it likewise includes a preliminary step of perforating said medium (2) and a step of transferring an additional sealing component (4) onto the second surface (13) of said medium (2), the additional component (4) including adhesive means (10) adhering to the second surface (13) of said medium (2), such that the transferred optical (3) and additional (4) components are bonded to one another through at least one perforation (14, 15) by means of the respective adhesive layers (5, 10) thereof.

20. Method according to claim 19, including, prior to the steps of transferring the optical component (3) and additional component (4), a step of writing customisation data (19) on said optical component (3) or said additional component (4), in the area of at least one perforation (14) through which said transferred optical (3) and additional (4) components will be bonded to one another.

21. Method according to claim 19, wherein the steps of transferring the optical component (3) and the additional component (4) are carried out simultaneously using a transfer medium (24) on which the optical (3) and additional (4) components are arranged on other side of a fold line (28).

22. Method according to claim 19, wherein the step of transferring the optical component (3) consists in preparing a transfer film (25) including a backing film (26) coated with a separation layer (27), which is itself coated with said optical component (3), in applying the transfer film (25) to the first surface (12) of the medium (2), and in then removing the backing film (26) and the separation layer (27) from said transfer film (25) of said separation layer (27).

23. Method according to claim 19, wherein the optical component (3) is obtained by coating a protective varnish (9) covering the entire outer surface of the optical component (3) with a stamped layer (6), a microrelief optical structure (7), a reflective transparent layer (8) and an adhesive layer (5).
